(19) United States
(12) Patent Application Publication
(10) Pub. No.: US 2012/0242664 A1
(43) Pub. Date: Sep. 27, 2012

(54) ACCELEROMETER-BASED LIGHTING AND EFFECTS FOR MOBILE DEVICES

(75) Inventors: Emmanuel J. Athans, Lake Forest Park, WA (US); Andrew S. Allen, Norwalk, CT (US); Christian Schormann, Seattle, WA (US); Jeffrey Stylos, Northampton, MA (US)

(73) Assignee: Microsoft Corporation, Redmond, WA (US)

(21) Appl. No.: 13/071,855

(22) Filed: Mar. 25, 2011

(51) Int. Cl. G06T 15/60; G09G 5/02

(52) U.S. Cl. 345/426; 345/589

(57) ABSTRACT

A mobile device and method for rendering graphical objects and dynamic effects associated therewith to a display of the mobile device are described. The mobile device includes a position and rotation tracking module, a graphics rendering module, and a display. The position and rotation tracking module generates data indicative of a change in position and/or rotation of the mobile device. The graphics rendering module processes the data to determine a spatial relationship between a graphical object to be rendered to the display and a virtual source. The graphics rendering module then renders the graphical object and at least one dynamic effect in association therewith to the display. The graphics rendering module renders the dynamic effect in a manner that is based at least in part on the determined spatial relationship between the graphical object and the virtual source.

### BACKGROUND

Graphics software and hardware exists that enable computers and other processor-based devices to digitally synthesize and manipulate visual content to be presented to a user via a display. In particular, three-dimensional (3D) graphics applications and the architectures that support them have enabled developers to present users with virtual environments that include photorealistic 3D objects that appear and interact in a manner similar to the manner in which such objects would appear and interact in the real world. However, such virtual environments are typically “disconnected” from the real world environment in which the devices that display them are located. For example, many software applications that render virtual objects and environments for display to a user can be executed on mobile devices such as smart phones, handheld video game devices, tablet computers, and the like. However, the appearance of objects rendered by such applications and the manner in which such objects interact with each other and the virtual environment typically has nothing to do with the state of the mobile device in the real world or the position of a user of the mobile device. This lack of connection between the virtual environment and the real-world environment can make the virtual environment seem static and non-immersive to a user of such a mobile device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

Mobile devices and methods for rendering graphical objects and dynamic effects associated therewith to the displays of such mobile devices are described herein. In accordance with certain embodiments, a position and rotation tracking module of a mobile device operates to detect changes in position and/or rotation of the mobile device. The position and rotation tracking module may comprise, for example, an accelerometer. A graphics rendering module of the mobile device processes data received from the position and rotation tracking module that is indicative of a position and/or rotational state of the mobile device and, based at least on such data, determines a spatial relationship between a graphical object to be rendered to a display of the mobile device and a virtual source. The graphics rendering module then renders the graphical object and at least one dynamic effect in association therewith to a display of the mobile device. The graphics rendering module renders the dynamic effect in a manner that is based at least in part on the determined spatial relationship between the graphical object and the virtual source.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of an example mobile device that renders graphical objects and associated dynamic effects to a display thereof in accordance with an embodiment.

FIG. 2 is a block diagram of an example application that renders graphical objects and associated dynamic effects to a display of a mobile device upon which such application is executing in accordance with one embodiment.

FIG. 3 illustrates the rendering of a graphical object and dynamic effects associated therewith to a display of a mobile device being held by a user in a particular position and rotational state in accordance with an embodiment.

FIG. 4 illustrates how a graphical object and dynamic effects associated therewith are rendered to the display of the mobile device of FIG. 3 after a user has changed the rotational state of the mobile device.

FIG. 5 illustrates how a graphical object and dynamic effects associated therewith are rendered to the display of the mobile device of FIG. 3 after a location of a virtual light source has changed.

FIG. 6 illustrates how a graphical object and dynamic effects associated therewith are rendered to the display of the mobile device of FIG. 3 after a location of a virtual light source has changed and after a user has changed the rotational state of the mobile device.

FIG. 7 illustrates how a graphical object and dynamic effects associated therewith are rendered to the display of the mobile device of FIG. 3 after a user has changed the position of the mobile device.

FIG. 8 depicts a flowchart of a method for rendering graphical objects and dynamic effects associated therewith to a display of a mobile device in accordance with an embodiment.

FIG. 9 depicts an example processor-based system that may be used to implement a mobile device in accordance with an embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Mobile devices and methods for rendering graphical objects and dynamic effects associated therewith to the displays of such mobile devices are described herein. In accordance with certain embodiments, a position and rotation tracking module of a mobile device operates to detect changes in position and/or rotation of the mobile device. The position and rotation tracking module may comprise, for example, an accelerometer. A graphics rendering module of the mobile device processes data received from the position and rotation tracking module that is indicative of a position and/or rotational state of the mobile device and, based at least on such data, determines a spatial relationship between a graphical object to be rendered to a display of the mobile device and a virtual source. The graphics rendering module then renders the graphical object and at least one dynamic effect in association therewith to a display of the mobile device. The graphics rendering module renders the dynamic effect in a manner that is based at least in part on the determined spatial relationship between the graphical object and the virtual source.

In accordance with certain embodiments, determining the spatial relationship between the graphical object and the virtual source comprises determining an orientation of the graphical object with respect to the virtual source and/or determining a distance between the graphical object and the virtual source.

In accordance with further embodiments, the virtual source comprises a virtual light source and rendering the at least one dynamic effect in associated with the graphical object comprises one or more of: rendering a specular highlight on the graphical object, wherein the position, shape and/or intensity of the specular highlight is determined based at least in part on the determined spatial relationship between the graphical object and the virtual light source; illuminating a portion of the graphical object, wherein the portion of the graphical object that is illuminated and/or the degree of illumination is determined based at least in part on the determined spatial relationship between the graphical object and the virtual light source; rendering a shadow of the graphical object, wherein the position, shape and/or intensity of the shadow is determined based at least in part on the determination spatial relationship between the graphical object and the virtual light source; and determining a normal map for the graphical object based at least in part on the determined spatial relationship between the graphical object and the virtual light source.

In alternative embodiments, the virtual source comprises a source other than a virtual light source, such as but not limited to, a virtual wind source, a virtual smoke source, a virtual fog source, or the like. In accordance with such embodiments, the dynamic effect that is rendered in association with the graphical object will vary depending upon the nature of the virtual source.

By utilizing data relating to the real-world position and rotational state of a mobile device to determine a spatial relationship between a graphical object to be rendered to a screen of the mobile device and a virtual source, and then rendering real-time dynamic effects based on such determined spatial relationship, embodiments described herein advantageously create a connection between a virtual environment being presented to a user of the mobile device and the real world in which the user finds himself/herself. The user of such a mobile device will feel as if his/her actions (such as moving or rotating the mobile device) in the real world are affecting the appearance of objects in the virtual environment, thus facilitating a more dynamic feel and more immersive user experience.

II. Example Mobile Device in Accordance with an Embodiment

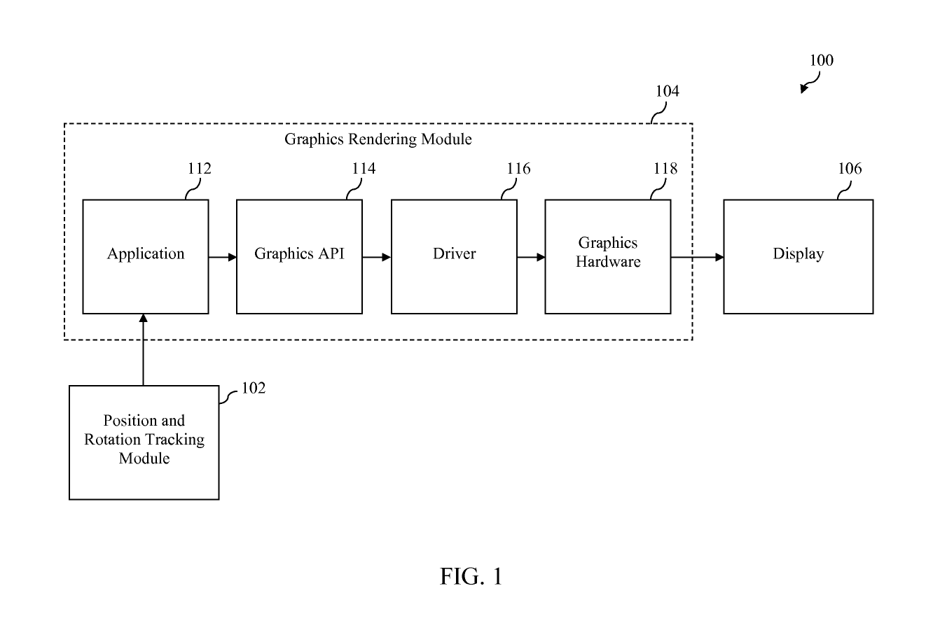

FIG. 1 is a block diagram of an example mobile device 100 in accordance with an embodiment. Mobile device 100 is intended to broadly represent any portable electronic device that is capable of rendering graphics to a display. For example and without limitation, mobile device 100 may comprise a cellular telephone, a smart telephone, a personal digital assistant, a personal media player, a handheld video gaming console, a tablet computer, or a laptop computer. As shown in FIG. 1, mobile device 100 includes a number of interconnected components including a position and rotation tracking module 102, a graphics rendering module 104 and a display 106. Each of these components will now be described.

Position and rotation tracking module 102 comprises a component that is configured to generate data that is indicative of a position and/or rotational state of mobile device 100. In one embodiment, position and rotation tracking module 102 comprises at least one sensor that is configured to detect acceleration of mobile device 100 in one or more directions. Such a sensor may be referred to as an accelerometer. Depending upon the type of accelerometer that is used, acceleration may be measured along one, two or three orthogonal axes. For example, by using the measurements provided by a three-axis accelerometer, acceleration of mobile device 100 in any direction can be sensed and quantified. Such acceleration may be caused, for example, by lifting, vibrating, rotating, tilting, or dropping mobile device 100. One example of an accelerometer that can provide an acceleration measurement along each of three orthogonal axes is the ADXL330 accelerometer which is an integrated circuit manufacture and sold by Analog Device of Norwood, Mass. However, this is only one example, and various other types of accelerometers may be used.

Position and rotation tracking module 102 may also include other types of sensors that may be used to generate data relating to a position or rotational state of mobile device 100. For example, position and rotation module 102 may include a compass sensor that is configured to determine a heading of mobile device 100 with respect to the magnetic field of the earth or an orientation sensor that is configured to detect an orientation of display 106 of mobile device 100 relative to gravity based on predefined orientation definitions. Still other types of sensors may be used.

Position and rotation tracking module 102 may additionally comprise a positioning system that is capable of automatically determining the location of mobile device 100. For example, position and rotation tracking module 102 may comprise a Global Positioning System (GPS) positioning system that utilizes a GPS receiver to track the current location of mobile device 100. Alternatively, position and rotation tracking module 102 may comprise a positioning system that communicates with 802.11 wireless local area network (WLAN) access points to determine a current location of mobile device 100 or a positioning system that communicates with base stations in a cellular network to determine a current location of mobile device 100.

Display 106 comprises is a piece of electrical equipment that operates as an output device for presentation of visual content transmitted electronically, for visual reception by a user. A variety of different display types are known in the art and are commonly used in conjunction with a variety of different mobile device types.

Graphics rendering module 104 is intended to represent one or more components of mobile device 100 that are configured to render graphical objects and other visual content to display 106 of mobile device 100 for viewing by a user thereof. As shown in FIG. 1, in one embodiment, graphics rendering module 104 includes an application 112, a graphics API 114, a driver 116 and graphics hardware 118. Each of these elements will now be described.

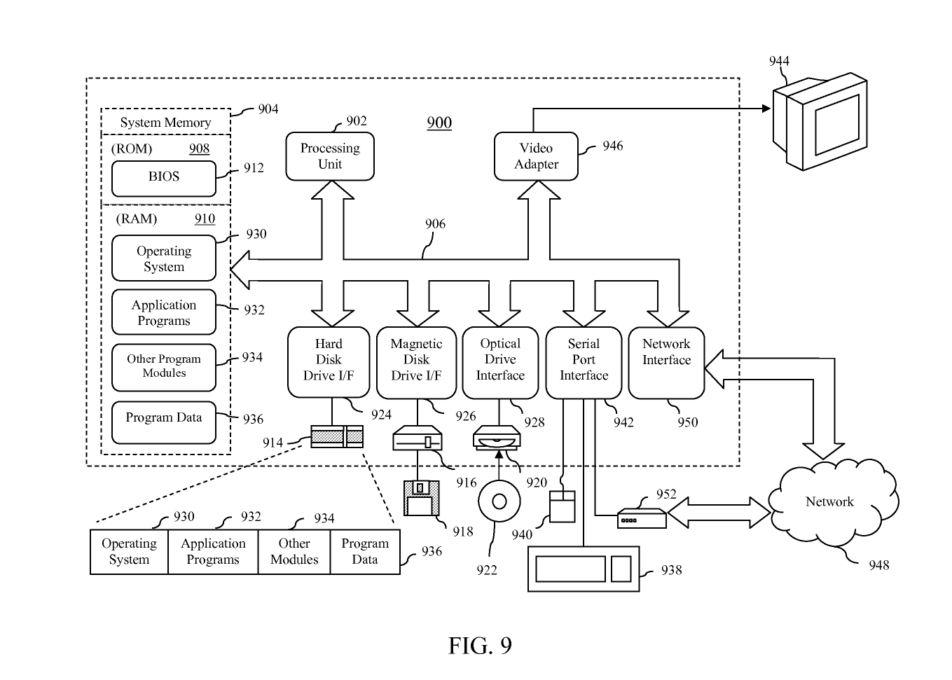

Application 112 is intended to represent a computer program that is executed by mobile device 100. In accordance with one implementation, mobile device 100 includes a processing unit that comprises one or more processors and/or processor cores and an operating system (OS) that is executed thereon. In accordance with such an implementation, application 112 may be executed within the context (or “on top of”) of the OS. One example of a processor-based implementation of mobile device 100 will be described below in reference to FIG. 9.

Application 112 comprises an end user application that is configured to digitally synthesize and manipulate visual content to be presented to a user via display 106. In particular, application 112 is configured to render graphical objects and other visual content to display 106. Such graphical objects may comprise, for example, two-dimensional (2D) or three-dimensional (3D) graphical objects. In accordance with certain embodiments, such graphical objects may comprise part of a virtual environment that is displayed to the user via display 106.

Depending upon the implementation, application 112 may represent, for example, a video game application, a utility application, a social networking application, a music application, a productivity application, a lifestyle application, a reference application, a travel application, a sports application, a navigation application, a healthcare and fitness application, a news application, a photography application, a finance application, a business application, an education application, a weather application, a books application, a medical application, or the like.

In the embodiment shown in FIG. 1, application 112 renders graphical objects and other visual content to display 106 by placing calls to a graphics application programming interface (API) 114. As will be appreciated by persons skilled in the art, graphics APIs have been developed to act as intermediaries between application software, such as application 112, and graphics hardware, such as graphics hardware 118. With new chipsets and even entirely new hardware technologies appearing at an increasing rate, it is difficult for application developers to take into account, and take advantage of, the latest hardware features. It is also becoming difficult to write applications specifically for each foreseeable set of hardware. APIs prevent applications from having to be too hardware-specific. An application can output graphics data and commands to the API in a standardized format, rather than directly to the hardware. Examples of available graphics APIs include DirectX® and OpenGL®. Graphics API 114 may comprise any one of the currently available graphics APIs.

Graphics API 114 communicates with driver 116. Driver 116 translates standard code received from graphics API 114 into a native format understood by graphics hardware 116. Driver 116 may also accepts input to direct performance settings for graphics hardware 116. Such input may be provided by a user, an application or a process. In one embodiment, driver 116 is published by a manufacturer of graphics hardware 118.

Graphics hardware 116 comprises circuitry that is configured to perform graphics processing tasks, including communicating with display 106 to cause graphical objects and other visual content to be rendered thereon. In one embodiment, graphics hardware 116 includes at least one graphics processing unit (GPU) although this example is not intended to be limiting.

As will be discussed in more detail herein, in addition to rendering graphical objects to display 106, application 112 is also configured to render real-time dynamic effects associated with such graphical objects to display 106, wherein the manner in which the dynamic effects are rendered is based at least in part on a determination spatial relationship between the graphical object and a virtual source. As will also be discussed in more detail herein, application 112 is configured to take into account a current position and/or rotational state of mobile device 100 in determining the spatial relationship between the graphical object and the virtual source. By utilizing data relating to the real-world position and rotational state of mobile device 100 in determining the spatial relationship between the graphical object and the virtual source and then rendering real-time dynamic effects based on such determined spatial relationship, application 112 can advantageously create a connection between a virtual environment being presented to a user of mobile device 100 and the real world in which the user finds himself/herself. The user of mobile device 100 will thus feel as if his/her actions (such as moving or rotating the mobile device) in the real world are affecting the appearance of objects in the virtual environment, thus facilitating a more dynamic feel and more immersive user experience.

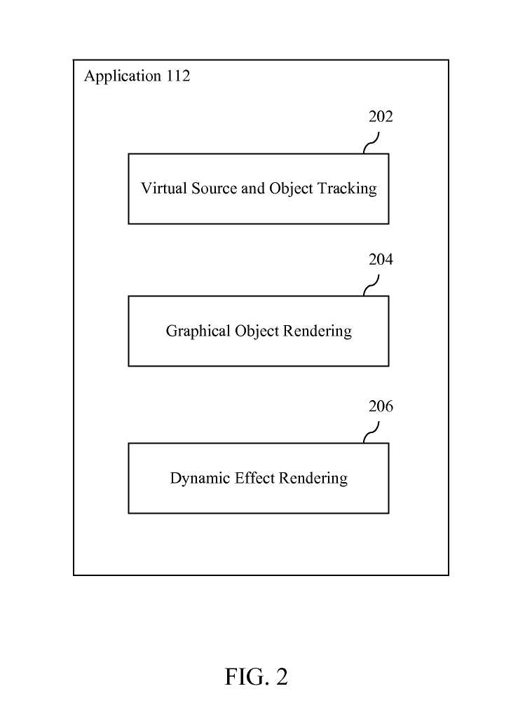

FIG. 2 is a block diagram 200 of application 112 in accordance with one embodiment. As shown in FIG. 2, application 112 includes a virtual source and object tracking module 202, a graphical object rendering module 204 and a dynamic effect rendering module 206. Each of these modules may comprise different functional elements of application 112. Alternatively, one or more of these modules may comprise a separate program or routine that is invoked by application 112 during execution. Each of these modules will now be described.

Virtual source and object tracking module 202 is a software module that is programmed to determine a spatial relationship between a graphical object to be rendered to display 106 and a virtual source. The virtual source may be associated with a virtual environment of which the graphical object is a part. In accordance with certain embodiments, the virtual source is a virtual light source. However, this is only one example, and virtual source may comprise other types of virtual sources including but not limited to a virtual wind source, a virtual smoke source, a virtual fog source, or the like.

Virtual source and object tracking module 202 may determine the spatial relationship between the graphical object and the virtual source by determining an orientation of the graphical object with respect to the virtual source. Determining an orientation of the graphical object with respect to the virtual source may comprise, for example and without limitation, determining a direction in which one or more portions or surfaces of the graphical object are facing relative to the virtual source. Virtual source and object tracking module 202 may also determine the spatial relationship between the graphical object and the virtual source by determining a distance between the graphical object and the virtual source.

To determine the spatial relationship between the graphical object and the virtual source, virtual source and object tracking module 202 takes into account data obtained from position and rotation tracking module 102 that indicates a current position or rotational state of mobile device 100. For example, in certain embodiments, the position and/or orientation of the graphical object in the virtual environment are determined based on the current position and/or rotational state of mobile device 100. This determined position and/or orientation of the graphical object is then used to determine the spatial relationship between the graphical object and the virtual source.

Graphical object rendering module 204 is a software module that is programmed to model the graphical object and render it to display 106. As noted above, in the embodiment shown in FIG. 1, graphical object rendering module 204 performs this function by placing one or more calls to graphics API 114.

Dynamic effect rendering module 206 is a software module that is programmed to render at least one dynamic effect in association with the graphical object to display 106, wherein the dynamic effect is rendered in a manner that is based at least in part on the spatial relationship between the graphical object and the virtual source as determined by virtual source and object tracking module 202. Dynamic effect rendering module 206 may render the at least one dynamic effect by placing one or more calls to graphics API 114. In certain embodiments, the dynamic effects are rendered as part of rendering the graphical object itself, in which case the same one more API calls may be used to render the graphical object and the dynamic effects associated therewith.

As noted above, in one embodiment, the virtual source comprises a virtual light source. In such a case, the dynamic effects may comprise effects that simulate the impact of the virtual light source upon the graphical object, wherein the nature of such impact is determined based on the spatial relationship between the graphical object and the virtual light source.

For example, dynamic effect rendering module 206 may be configured to render a specular highlight on the graphical object, wherein the position, shape and/or intensity of the specular highlight is determined based at least in part on the spatial relationship between the graphical object and the virtual light source.

As another example, dynamic effect rendering module 206 may be configured to illuminate a portion of the graphical object, wherein the portion of the graphical object that is illuminated and/or the degree of illumination is determined based at least in part on the determined spatial relationship between the graphical object and the virtual light source.

As a further example, dynamic effect rendering module 206 may be configured to render a shadow of the graphical object, wherein the position, shape and/or intensity of the shadow is determined based at least in part on the determined spatial relationship between the graphical object and the virtual light source.

As a still further example, dynamic effect rendering module 206 may be configured to determine a normal map for the graphical object based at least in part on the determined spatial relationship between the graphical object and the virtual light source and to apply the normal map to the graphical object.

The foregoing are only a few examples of the manner in which dynamic effects may be used to simulate the impact of a virtual light source upon a graphical object, wherein the manner in which the dynamic effect is rendered is based at least in part on a spatial relationship between the graphical object and the virtual light source. Persons skilled in the relevant art(s) will appreciate that still other dynamic effects may be used.

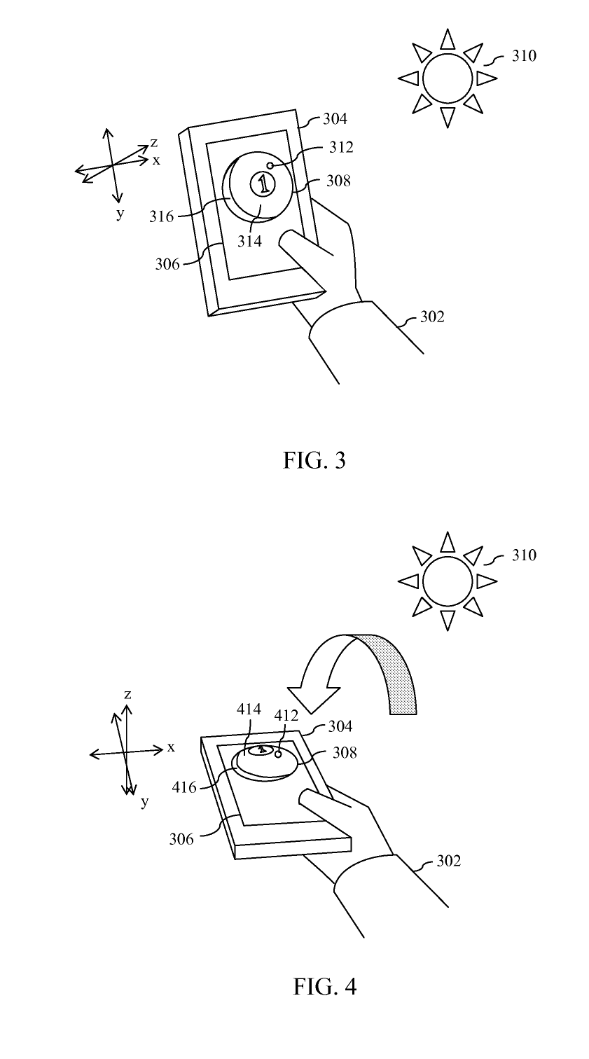

A number of example use cases will now be described in reference to FIGS. 3-7 to help demonstrate a manner by which the various components described above can operate to render graphical objects to display 106 of mobile device 100. In the example use cases, the virtual source comprises a virtual light source. However, as noted above, embodiments described herein may also be used to render dynamic effects associated with other types of virtual sources as well.

As shown in FIG. 3, a user 302 is holding a mobile device 304 in a particular position and rotational state. Mobile device 304 is intended to represent one example of mobile device 100 as described above in reference to FIG. 1. A graphical object 308 that is intended to represent a billiard ball is rendered to a display 306 of mobile device 304. Various dynamic effects are also rendered to display 306 in association with graphical object 308. These dynamic effects include a specular highlight 312 on graphical object 308, illumination of a first portion 314 of graphical object 308, and shading of a second portion 314 of graphical object 308.

To determine the manner in which such dynamic effects are rendered, virtual source and object tracking module 202 of application 112 determines a spatial relationship between a virtual light source 310 and graphical object 308. The position and orientation of graphical object 308 in virtual space is determined based at least in part on the position and rotational state of mobile device 100. In accordance with the example of FIG. 3, virtual light source 310 is intended to appear as if it is located above the right-hand shoulder of user 302. Based on the position and orientation of graphical object 308 and the position of virtual light source 310 in virtual space, virtual source and object tracking module 202 may thus determine that virtual light source 310 is a certain distance away from graphical object 308 and that light from virtual light source 310 will impact graphical object 308 at a certain angle. Using this information, dynamic effect rendering module 206 can operate to cause specular highlight 312 to be rendered at a particular position on graphical object 308 and with a particular intensity that is consistent with the current spatial relationship between graphical object 308 and virtual light source 310. Using this information, dynamic effect rendering module 206 can also operate to illuminate first portion 314 of graphical object 308 and shade second portion 316 of graphical object 308 in a manner that is consistent with the current spatial relationship between graphical object 308 and virtual light source 310.

FIG. 4 illustrates how graphical object 308 and the dynamic effects associated therewith are rendered to display 306 after user 302 has changed the rotational state of mobile device 304. As a result of the change in rotational state, virtual source and object tracking module 202 determines that the orientation of graphical object 308 in virtual space has changed relative to virtual light source 310, such that a different portion of graphical object 308 (i.e., a different portion of the billiard ball) will be impacted by light from virtual light source 310. Using this information, dynamic effect rendering module 206 can operate to cause a specular highlight 412 to be rendered at a new position on graphical object 308 that is consistent with the changed spatial relationship between graphical object 308 and virtual light source 310. Using this information, dynamic effect rendering module 206 can also operate to illuminate a first portion 414 of graphical object 308 and shade a second portion 416 of graphical object 308 in a manner that is consistent with the changed spatial relationship between graphical object 308 and virtual light source 310.

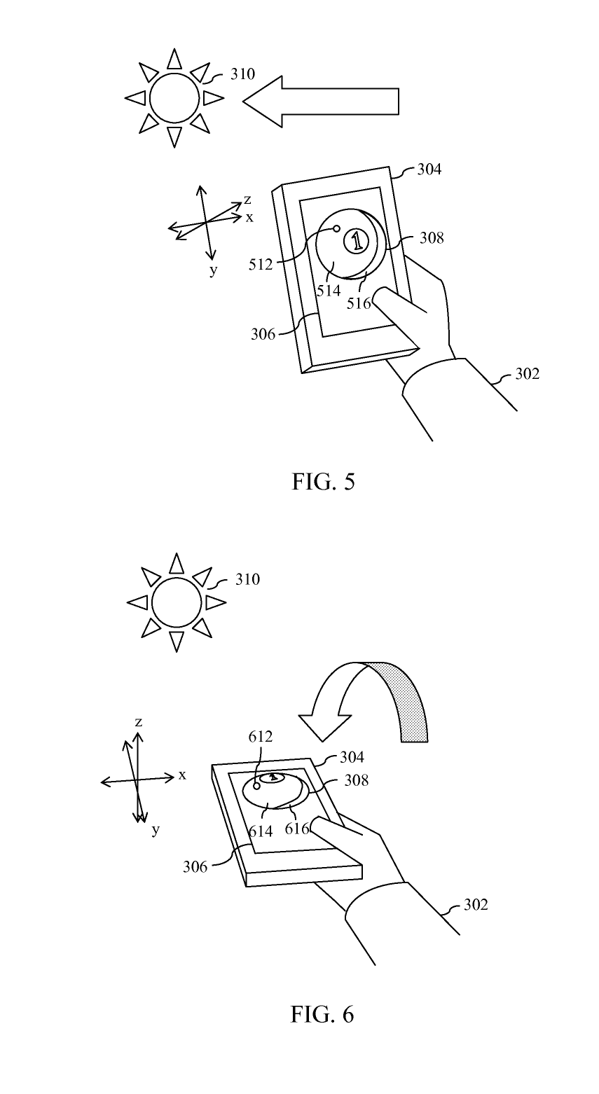

FIG. 5 illustrates how graphical object 308 and the dynamic effects associated therewith are rendered to display 306 after the position of virtual light source 310 in virtual space has changed. In accordance with the example of FIG. 3, virtual light source 310 has now moved to a position that corresponds to appearing over the left-hand shoulder of user 302. As a result of the change in position of virtual light source 310, virtual source and object tracking module 202 determines that a different portion of graphical object 308 will be impacted by light from virtual light source 310. Using this information, dynamic effect rendering module 206 can operate to cause a specular highlight 512 to be rendered at a new position on graphical object 308 that is consistent with the changed spatial relationship between graphical object 308 and virtual light source 310. Using this information, dynamic effect rendering module 206 can also operate to illuminate a first portion 514 of graphical object 308 and shade a second portion 516 of graphical object 308 in a manner that is consistent with the changed spatial relationship between graphical object 308 and virtual light source 310.

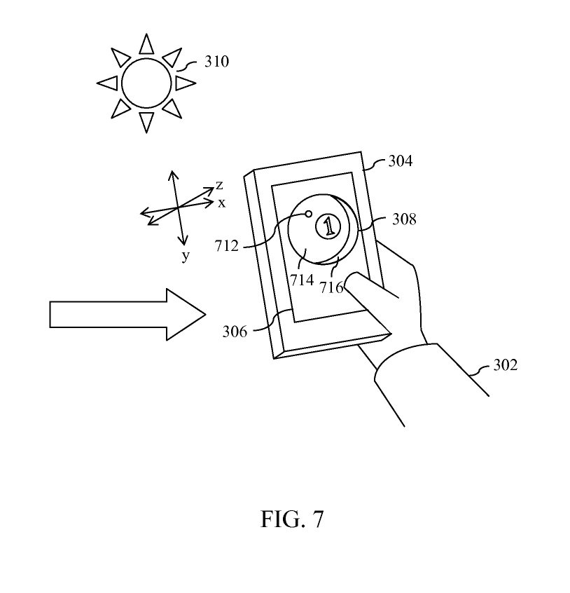

FIG. 6 illustrates how graphical object 308 and the dynamic effects associated therewith are rendered to display 306 after virtual light source 310 has moved to the new position shown in FIG. 5 and after user 302 has also changed the rotational state of mobile device 304. As a result of the change in rotational state, virtual source and object tracking module 202 determines that the orientation of graphical object 308 in virtual space has changed relative to the new position of virtual light source 310, such that a different portion of graphical object 308 will be impacted by light from virtual light source 310. Using this information, dynamic effect rendering module 206 can operate to cause a specular highlight 612 to be rendered at a new position on graphical object 308 that is consistent with the changed spatial relationship between graphical object 308 and virtual light source 310. Using this information, dynamic effect rendering module 206 can also operate to illuminate a first portion 614 of graphical object 308 and shade a second portion 616 of graphical object 308 in a manner that is consistent with the changed spatial relationship between graphical object 308 and virtual light source 310.

FIG. 7 illustrates how graphical object 308 and the dynamic effects associated therewith are rendered to display 306 after user 302 has moved mobile device 304 from its original position as shown in FIG. 4. This example assumes that the position of graphical object 308 is “locked” to the position of mobile device 304. In accordance with the example, user 302 has shifted mobile device to the left such that virtual light source 310 is now above and to the left of graphical object 308 rather than above and to the right of graphical object 308 as shown in FIG. 4. As a result of this change in position, virtual source and object tracking module 202 determines that a different portion of graphical object 308 will be impacted by light from virtual light source 310. Using this information, dynamic effect rendering module 206 can operate to cause a specular highlight 712 to be rendered at a new position on graphical object 308 that is consistent with the changed spatial relationship between graphical object 308 and virtual light source 310. Using this information, dynamic effect rendering module 206 can also operate to illuminate a first portion 714 of graphical object 308 and shade a second portion 716 of graphical object 308 in a manner that is consistent with the changed spatial relationship between graphical object 308 and virtual light source 310.

The foregoing illustrates only some dynamic effects that may be utilized in accordance with the embodiments described herein. Persons skilled in the relevant art(s) will appreciate that other dynamic effects may also be rendered in a manner that is based on the determined spatial relationship between graphical object 308 and virtual light source 310. Furthermore, other types of virtual sources may be used. For example, instead of a virtual light source, a virtual wind source may be used and the appearance of a graphical object may be dynamically changed based on the position and/or orientation of the graphical object with respect to the virtual wind source. In each case, the determined spatial relationship between the graphical object and the virtual source is determined based at least in part on the current position and/or rotational state of the mobile device.

### III. Example Method for Rendering of Graphical Objects and Dynamic Effects Associated Therewith

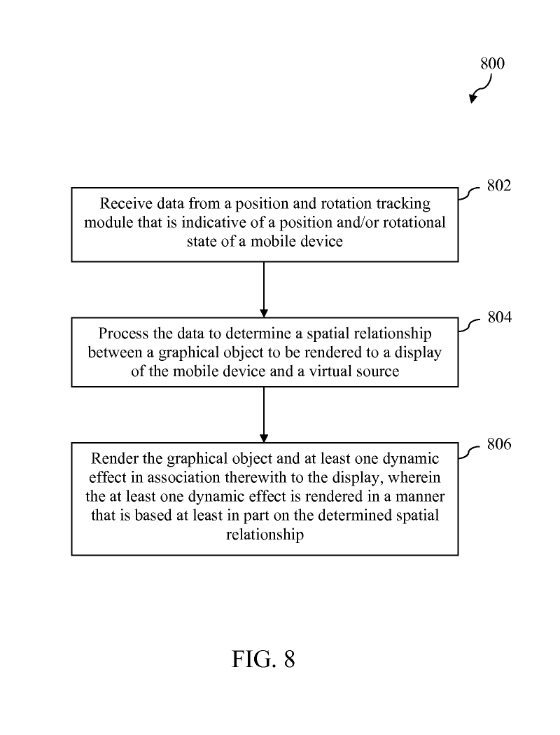

FIG. 8 depicts a flowchart 800 of a method for rendering graphical objects and dynamic effects associated therewith to a display of a mobile device in accordance with an embodiment. The method of flowchart 800 will now be described with continued reference to the components of example mobile device 100 as described above in reference to FIGS. 1 and 2. However, persons skilled in the relevant art(s) will appreciate that the method of flowchart 800 may be performed by different components.

As shown in FIG. 8, the method of flowchart 800 begins at step 802, in which virtual source and object tracking module 202 of application 112 receives data from a position and rotation tracking module 102 that is indicative of a position and/or rotational state of mobile device 100. As discussed above, in certain embodiments, this step may comprise receiving data from an accelerometer, some other type of sensor, or a positioning system.

At step 804, virtual source and object tracking module 202 processes the data received during step 802 to determine a spatial relationship between a graphical object to be rendered to display 106 and a virtual source. Processing the data to determine the spatial relationship between the graphical object and the virtual light source may comprise determining an orientation of the graphical object with respect to the virtual light source. Processing the data to determine the spatial relationship between the graphical object and the virtual light source may also comprise determining a distance between the graphical object and the virtual light source.

At step 806, graphical object rendering module 204 and dynamic effect rendering module 206 of application 112 render the graphical object and at least one dynamic effect in association therewith to the display, wherein the at least one dynamic effect is rendered in a manner that is based at least in part on the determined spatial relationship between the graphical object and the virtual source.

In an embodiment in which the virtual source comprises a virtual light source, step 806 may comprise, for example and without limitation: rendering a specular highlight on the graphical object, wherein the position, shape and/or intensity of the specular highlight is determined based at least in part on the determined spatial relationship between the graphical object and the virtual light source; illuminating a portion of the graphical object, wherein the portion of the graphical object that is illuminated and/or the degree of illumination is determined based at least in part on the determined spatial relationship between the graphical object and the virtual light source; rendering a shadow of the graphical object, wherein the position, shape and/or intensity of the shadow is determined based at least in part on the determined spatial relationship between the graphical object and the virtual light source; and determining :normal map for the graphical object based at least in part on the determined spatial relationship between the graphical object and the virtual light source.

### IV. Example Processor-Based Implementations

FIG. 9 depicts an example processor-based system 900 that may be used to implement a mobile device in accordance with an embodiment. For example, mobile device 100 of FIG. 1 may be implemented using processor-based system 900. The description of processor-based system 1100 provided herein is provided for purposes of illustration, and is not intended to be limiting. Embodiments may be implemented in further types of computer systems, as would be known to persons skilled in the relevant art(s).

As shown in FIG. 9, processor-based system 900 includes a processing unit 902, a system memory 904, and a bus 906 that couples various system components including system memory 904 to processing unit 902. Processing unit 902 may comprise one or more processors or processing cores. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Processor-based system 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 930, one or more application programs 932, other program modules 934, and program data 936. In accordance with certain embodiments, application programs 932 include application 112 as described above in reference to FIGS. 1 and 2, operating system 930 or other program modules 934 include graphics API 114, and other program modules 934 includes driver 116. Thus, when executed, application programs 932, operating system 930 and program modules 934 can perform functions and features described above, including but not limited to methods such as those described above in reference to flowchart 800 of FIG. 8.

A user may enter commands and information into processor-based system 900 through input devices such as a keyboard 938 and a pointing device 940. Other input devices (not shown) may include a microphone, joystick, game controller, scanner, or the like. In one embodiment, a touch screen is provided in conjunction with a display 944 to allow a user to provide user input via the application of a touch (as by a finger or stylus for example) to one or more points on the touch screen. These and other input devices are often connected to processing unit 902 through a serial port interface 942 that is coupled to bus 906, but may be connected by other interfaces, such as a parallel port, game port, or a universal serial bus (USB).

A display 944 is also connected to bus 906 via an interface, such as a video adapter 946. Display 944 may correspond to display 106 of mobile device 100 and video adapter 946 may comprise at least a portion of graphics hardware 118 as described above in reference to FIG. 1. In addition to display 944, processor-based system 900 may include other peripheral output devices (not shown) such as speakers and printers.

Processor-based system 900 is connected to a network 948 (e.g., a local area network or wide area network such as the Internet) through a network interface or adapter 950, a modem 952, or other means for establishing communications over the network. Modem 952, which may be internal or external, is connected to bus 906 via serial port interface 942.

As used herein, the terms “computer program medium” and “computer-readable medium” are used to generally refer to non-transitory media such as the hard disk associated with hard disk drive 914, removable magnetic disk 918, removable optical disk 922, as well as other media such as flash memory cards, digital video disks, random access memories (RAMs), read only memories (ROM), and the like.

As noted above, computer programs and modules (including application programs 932 and other program modules 934) may be stored on the hard disk, magnetic disk, optical disk, ROM, or RAM. Such computer programs may also be received via network interface 950 or serial port interface 942. Such computer programs, when executed or loaded by an application, enable computer 900 to implement features of embodiments discussed herein. Accordingly, such computer programs represent controllers of computer system 900.

Embodiments are also directed to computer program products comprising software stored on any computer-readable medium. Such software, when executed in one or more data processing devices, causes a data processing device(s) to operate as described herein. Embodiments may employ any computer-usable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for rendering graphical objects and dynamic effects associated therewith to a display of a mobile device, comprising:
receiving data from an accelerometer that is indicative of a position or rotational state of the mobile device;
processing the data to determine a spatial relationship between a graphical object to be rendered to the display of the mobile device and a virtual light source; and
rendering the graphical object and at least one dynamic effect in association therewith to the display, wherein the at least one dynamic effect is rendered in a manner that is based at least in part on the determined spatial relationship between the graphical object and the virtual light source.

2. The method of claim 1, wherein processing the data to determine the spatial relationship between the graphical object and the virtual light source comprises determining an orientation of the graphical object with respect to the virtual light source.

3. The method of claim 1, wherein processing the data to determine the spatial relationship between the graphical object and the virtual light source comprises determining a distance between the graphical object and the virtual light source.

4. The method of claim 1, wherein rendering the at least one dynamic effect in association with the graphical object comprises rendering a specular highlight on the graphical object, wherein the position, shape and/or intensity of the specular highlight is determined based at least in part on the determined spatial relationship between the graphical object and the virtual light source.

5. The method of claim 1, wherein rendering the at least one dynamic effect in association with the graphical object comprises illuminating a portion of the graphical object, wherein the portion of the graphical object that is illuminated and/or the degree of illumination is determined based at least in part on the determined spatial relationship between the graphical object and the virtual light source.

6. The method of claim 1, wherein rendering the at least one dynamic effect in association with the graphical object comprises rendering a shadow of the graphical object, wherein the position, shape and/or intensity of the shadow is determined based at least in part on the determined spatial relationship between the graphical object and the virtual light source.

7. The method of claim 1, wherein rendering the at least one dynamic effect in association with the graphical object comprises determining a normal map for the graphical object based at least in part on the determined spatial relationship between the graphical object and the virtual light source.

8. A mobile device, comprising:
a display;
a position and rotation tracking module that is configured to detect changes in position and rotation of the mobile device;
a graphics rendering module that is configured to receive data from the position and rotation tracking module, the data being indicative of a position or rotational state of a mobile device, to process the data to determine a spatial relationship between a graphical object to be rendered to the display and a virtual source, and to render the graphical object and at least one dynamic effect in association therewith to the display, wherein the dynamic effect is rendered in a manner that is based at least in part on the determined spatial relationship between the graphical object and the virtual source.

9. The mobile device of claim 8, wherein the position and rotation tracking module comprises at least one accelerometer.

10. The mobile device of claim 8, wherein the mobile device comprises one of a smart telephone, a tablet computer, a laptop computer, a personal media player, or a personal digital assistant.

11. The mobile device of claim 8, wherein the graphics rendering module is configured to process the data to determine an orientation of the graphical object with respect to the virtual source.

12. The mobile device of claim 8, wherein the graphics rendering module is configured to process the data to determine a distance between the graphical object and the virtual source.

13. The mobile device of claim 8, wherein the graphics rendering module is configured to process the data to determine a spatial relationship between the graphical object and a virtual light source and to render a specular highlight on the graphical object, wherein the position, shape and/or intensity of the specular highlight is determined based at least in part on the determined spatial relationship between the graphical object and the virtual light source.

14. The mobile device of claim 8, wherein the graphics rendering module is configured to process the data to determine a spatial relationship between the graphical object and a virtual light source and to illuminate a portion of the graphical object, wherein the portion of the graphical object that is illuminated and/or the degree of illumination is determined based at least in part on the determined spatial relationship between the graphical object and the virtual light source.

15. The mobile device of claim 8, wherein the graphics rendering module is configured to process the data to determine a spatial relationship between the graphical object and a virtual light source and to render a shadow of the graphical object, wherein the position, shape and/or intensity of the shadow is determined based at least in part on the determined spatial relationship between the graphical object and the virtual light source.

16. The mobile device of claim 8, wherein the graphics rendering module is configured to process the data to determine a spatial relationship between the graphical object and a virtual light source and to determine a normal map for the graphical object based at least in part on the determined spatial relationship between the graphical object and the virtual light source.

17. The mobile device of claim 8, wherein the graphics rendering module is configured to process the data to determine a spatial relationship between the graphical object and one of a virtual wind source, a virtual smoke source, or a virtual fog source with respect to the graphical object.

18. A computer program product comprising a computer-readable storage medium having computer program logic recorded thereon for enabling a processing unit to for render a graphical object to a display of a mobile device, the computer program logic comprising:
first means for enabling the processing unit to receive data indicative of a position or rotational state of a mobile device;
second means for enabling the processing unit to process the data to determine a spatial relationship between a graphical object to be rendered to the display and a virtual source; and
third means for enabling the processing unit to render the graphical object and at least one dynamic effect in association therewith to the display, wherein the dynamic effect is rendered in a manner that is based at least in part on the determined spatial relationship between the graphical object and the virtual source.

19. The computer program product of claim 18, wherein the graphical object comprises a two-dimensional graphical object.

20. The computer program product of claim 18, wherein the graphical object comprises a three-dimensional graphical object.
